(19) United States
(12) Patent Application Publication
(10) Pub. No.: US 2009/0282002 A1
(43) Pub. Date: Nov. 12, 2009

(54) METHODS AND SYSTEMS FOR INTEGRATING DATA FROM SOCIAL NETWORKS

(76) Inventors: Travis Reeder, Emeryville, CA (US); Matt Bradley, San Francisco, CA (US)

Correspondence Address: WILSON, SONSINI, GOODRICH & ROSATI, 650 PAGE MILL ROAD, PALO ALTO, CA, 94304-1050, US

(21) Appl. No.: 12/401,552

(22) Filed: Mar. 10, 2009

Related U.S. Application Data
(60) Provisional application No. 61/035,365, filed on Mar. 10, 2008.

(51) Int. Cl. G06F 17/30; G06F 3/048

(52) U.S. Cl. 707/3; 715/764; 707/E17.014

(57) ABSTRACT

Methods and systems for integrating data from social networks. The methods and systems may gather data from social networking sites and sites with user review and advocacy data, and merge the data to create universal profiles for Internet users. The methods and systems may also integrate social networking data with user review and advocacy data to provide customized search results to search queries generated by users.

### CROSS-REFERENCE

This application claims the benefit of U.S. Provisional Application No. 61/035,365 filed Mar. 10, 2008, which application is incorporated herein by reference in its entirety.

### FIELD OF INVENTION

The invention relates to social networking and integrating data. More particularly, the invention relates to methods and systems for integrating data from social networks.

### BACKGROUND

Much of the information we use today is stored on computers or other devices such as PDAs that use computer technology. E-mail messages, word processing documents, and digital photographs are just a few common types of content items that are available to users. Because of the large sizes of these collections of content items, it can be difficult for users to find the information for which they are looking. A search engine is a software system used to facilitate the process of finding information in a collection of content items. Users express their information need in the form of a query (which typically comprises one or more query terms), and the search engine returns a list of content items that match the query in some manner.

The Internet is a worldwide network of interconnected networks, which includes both public and private local and wide area networks of computers. One of the most commonly used Internet services is the World Wide Web (“WWW”), which consists of billions of content items, known as web pages, interconnected by hypertext links which allow users to navigate from a “source” page (the page containing the link) to a “target” page (the page pointed to by the link), Each page on the Web has a unique address known as a Uniform Resource Locator (“URL”). Hypertext links on the web contain two pieces of information: the URL of the target page, and a short piece of text, known as anchortext, that describes the target page.

Due to the large scale of the Web and the unique nature of the interlinked pages, web search engines typically employ complex relevance ranking functions. In addition to the ranking features used in traditional search engines, web search engines also rely on information based on the connectivity of the page, such as the number of pages linking to it, in determining the relevance score of a search result. Ranking based on connectivity of the page, however, does not always yield the most relevant items in a result set. Further, because of the deficiencies of ranking functions, users are increasingly presented with disinformation when attempting to locate content items on the Internet.

Consumer Generated Media (“CGM”), a particular type of content found on the Internet, has grown at an enormous rate with the growth of the Internet. Today's Internet user often contributes in a variety of ways to the content through a number of web pages or sites, including web logs or “blogs”, mobile phone blogs, video hosting blogs, forums, electronic discussion messages, Usenet, message boards, BBS emulating services, product review and discussion web sites, online retail sites that support customer comments, social networks, media repositories, audio and video sharing sites or networks, and digital libraries. Private non-Internet information systems can host CGM content as well, via environments like Sharepoint, Wiki, Jira, CRM systems, ERP systems, and advertising systems. Further, private non-Internet networks may collect private non-public data of users as well, including user preferences or private information stored by a user in their profile, comments, messages, resume, etc. As used herein, the term CGM is a phrase that describes a wide variety of content on a variety of Internet web pages or sites, including, without limitation, all of the content described in this paragraph as well as any similar information that may fall in the category of information generated by an Internet user.

Blogs and social networks, both public and private, and a variety of other sites that offer communication mediums that permit author control, reduce the cost, technical sophistication, and experience required to create and administer such communication mediums. By reducing the overhead, such sites have given an unprecedented amount of editorial control to millions of online authors. This has created a unique new environment for creative expression, commentary, discourse, and criticism without the historical limits of editorial control, cost, technical expertise, or distribution or exposure, as well as a unique new environment for the collection of data, both public and private.

There is a significant value in the information contained within this media. With regard to public media, because the opinions, topics of discussion, brands and celebrities mentioned and relationships evinced are typically totally unsolicited, the information presented, if well studied, represents an amazing new source of social insight, consumer feedback, opinion measurement, popularity analysis and messaging data. It also represents a fully exposed, granular network of peer and hierarchical relationships rich with authority and influence. The marketing, advertising, and PR value of this information is unprecedented in the public realm. Further, in the private realm, this information similarly represents a rich source of information.

This new medium represents a significant challenge for interested parties to comprehensively understand and interact with. As of Q1 2007 estimates for the number of active, unique online CGM sites (forums, blogs, social networks, etc.) range from 50 to 71 million, with growth rates in the hundreds of thousands of new sites per day. Compared to the typical mediums that PR, Advertising and Marketing businesses and divisions interact with (<1000 TV channels, <1000 radio stations, <1000 major news publications, <10-20 major pundits on any given subject, etc.) this represents a nearly 10,000-fold increase in the number of potential targets for interaction. The result is a massively diverse community that would be very valuable to understand and interact with, but presents difficulties for doing so because of sheer size and diversity of data.

What is needed is an effective way to integrate CGM with searching and ranking functions in order to help users comprehensively understand and interact with the abundance of data. Particularly, new sources of information on which to base searches and rank search results, as well as methods of using the same, are needed.

### SUMMARY OF INVENTION

The invention provides methods and systems for integrating data from social networks. Various aspects of the invention described herein may be applied to any of the particular applications set forth below. The invention may be applied as a standalone system or as revenue generating component of an integrated software solution for providing integrated information in a different context. The invention can be optionally integrated into search and ranking processes or other processes which display the information seamlessly. It shall be understood that different aspects of the invention can be appreciated individually, collectively or in combination with each other.

A preferable embodiment of the invention provides for the integration of data from social networking sites and sites with user review and advocacy data. Data from social networking sites may include user profile information, a social network graph, other information about social network connections, as well as private data or preferences of a user. Such data from social networking sites may be collected through a site's open application programming interfaces. In another embodiment of the invention, the data from social networking sites may be gathered through partnerships with the social networking sites. For example, data might be gathered through partnerships with social networking sites such as Facebook or Linkedin, or from sites that participate in OpenSocial. In one embodiment, partners may be provided with software programming code to place on their web pages, making it easy for partners to utilize the invention.

In addition, user profile information, a social network graph, other information about social network connections, as well as private data or preferences of a user may be gathered from individual users about the user. For example, data can be attained from an individual user about that user, or from an individual user about a network connection. In addition, information may be obtained from a network connection to ascertain information about a user. One of ordinary skill in the art can appreciate that there are a variety of other ways that such data may be collected from social networking sites, there are a variety of other types of data that may be collected from social networking sites, and there are a variety of other social networking sites that such social networking data may be gathered from.

The invention may also gather data from sites with user review and advocacy data. In one embodiment of the invention, data would be gathered from a variety of sites such as Yelp.com, Amazon.com, epinions.com or other sites with user review and advocacy data. Alternatively, data could be gathered from any site with CGM. Such data could be gathered through the application programming interfaces of the sites that the information is stored on. In another embodiment of the invention, data may be gathered through partnerships with other social networking sites or other web sites visited by users. In another embodiment of the invention, data may be gathered through direct questions to users while the user is browsing the social networking site or any other web site. Users may be asked questions through social networking sites or other partnering sites. Such questions may be asked while they browse the social network or also after they conduct web searches.

The invention may store the relationships between the social network data of a user and their profiles on other, non-social networking sites. In one embodiment of the invention, this data can be merged to create a Universal Profile for each user and can include all of the information collected for that user. The Universal Profile of each user may also include a social network graph or connections to show the user's connections to other user's Universal Profiles.

In one embodiment of the invention, when a user performs a search, the system may deliver the most appropriate and relevant responses based on what the user is searching for and the data contained within that user's realm of network connections. In this way, the system may customize search results for each user, so that the user will see results relating to their search in a sidebar or on top. The customized search results of a user may show CGM generated by another user in the user's social network graph. Such information may include the other user's name, profile information, rating of a product, a comment, a review, etc., and may also show the connection relationship. Further, the system may present the user with links for asking the other user a question or sending a message through the system, or an option to get more information about that user or his or her opinions.

In another embodiment of an invention, the system may show degrees of separation of connections, including the relationship between two users as well as how many steps away they are from a person in the social network.

According to one embodiment of the invention, the system may integrate with other product sites, searching sites, or any site which presents information, to provide the social network information integrated and in a different context.

Further, another embodiment of the invention may match keywords from a user initiated search query to messages sent between users in social networks. Thus, when generating customized search results for a user, the system may show messages containing certain keywords in the user's search queries as part of the user's search results.

According to one embodiment of the invention, an advertiser may use the invention in order to select which endorsements to show to the user. Such endorsements may be shown in a sidebar, on top of the page, or elsewhere on the page, when a user enters certain keywords into the user's search query, as part of the user's search results. In one embodiment, the endorsements may be competitive in that the user may be shown products or results that are competitive to the keywords that the user is looking for. In another embodiment, the results may be complementary, showing user reviews or advocacy data stored by the system for a certain product keyword, for example. In another embodiment, product endorsements or other kinds of endorsements may be shown based on a topic or based on certain keywords entered by the user.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Some of the features of the invention are described as set forth in the following figures and description. A better understanding of the features and advantages of the invention will be obtained by reference to the following detailed description that sets forth illustrative embodiments provided in accordance with the invention.

FIG. 1 describes system that integrates data between social networking sites and sites containing user review and advocacy data over the Internet.

FIG. 2 shows the different parts of the system that integrates data between social networking sites and site containing user review and advocacy data.

FIG. 3 shows a user interface for gathering user review and advocacy data from users.

FIG. 4 shows examples of questions that may be asked for gathering user review and advocacy data from users.

FIG. 5 shows search results based on user queries and data contained within the user's realm of network connections.

FIG. 6 shows the system as integrated with an online store.

FIG. 7 describes a system that integrates data between social networking sites and sites containing user review and advocacy data over the Internet.

FIG. 8 shows an example of the system as integrated with a search engine.

FIG. 9 shows an example of the system as integrated with an online store.

FIG. 10 shows an example of the system as integrated with an online store.

FIG. 11 shows an example of how the results may be displayed on a web page.

### DETAILED DESCRIPTION OF INVENTION

In the following detailed description, numerous specific details are set forth in order to provide a thorough understanding of the invention. However it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

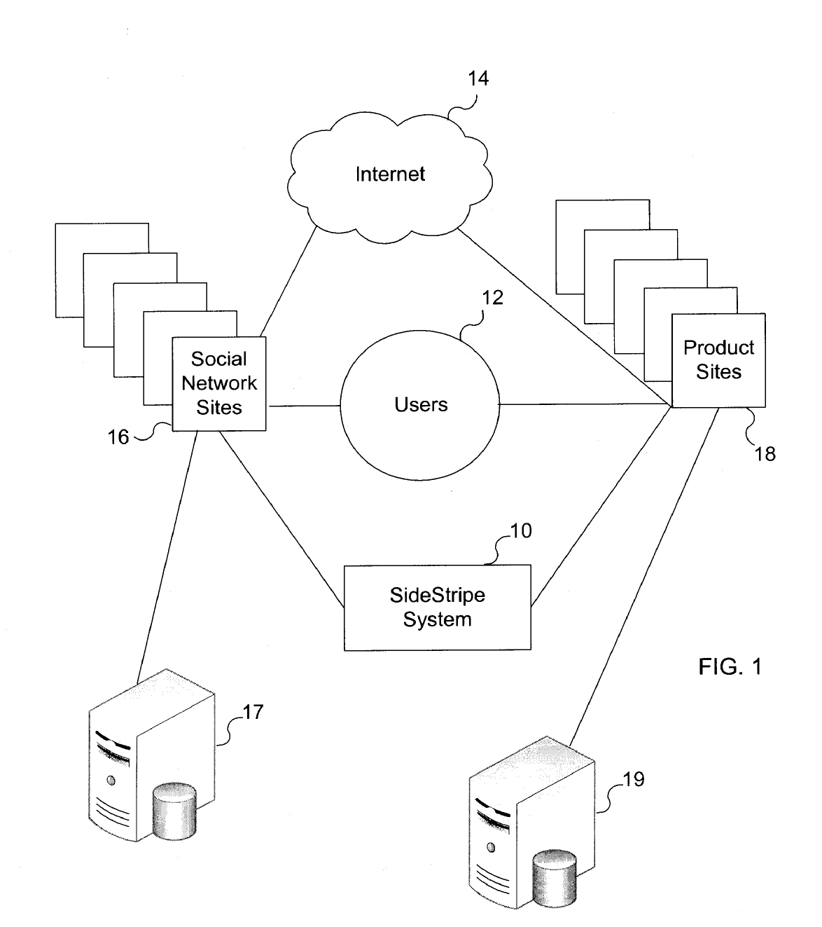

Referring to the drawings in detail, FIG. 1 shows a system 10 for integrating data from social networking sites 16 and user review data and advocacy data from other sites, for example product sites 18 over the Internet 14. Data from social networking sites 16 may include user profile information, a social network graph, or other information about social network connections stored and managed by a server coupled with a database 17. Further, data from social networking sites 16 may also include private or non-public data collected, including, for example and without limitation, the last time a user went on vacation, the user's favorite ice cream, or the user's political affiliation. User review data and advocacy data from other sites, for example product sites 18, may also store and manage data through a server coupled with a database 19.

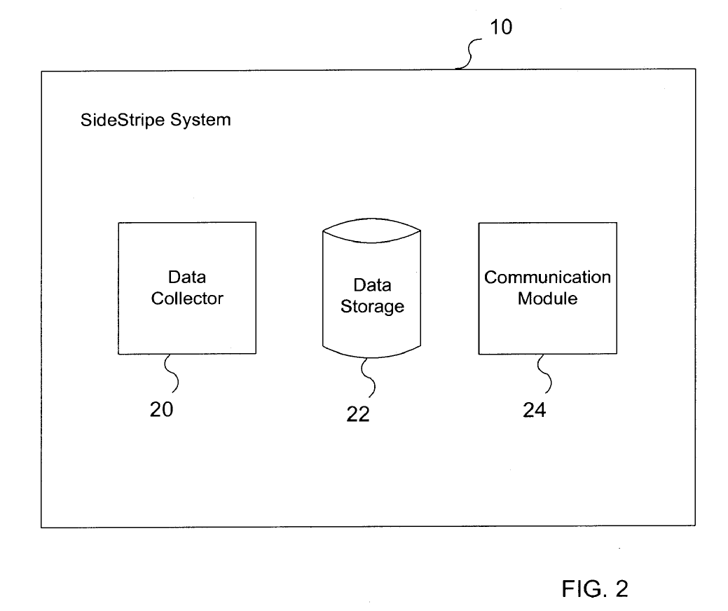

Referring to FIG. 2, a data collector 20 may collect the data from social networking sites 16 through the social networking sites' open application programming interfaces via a communication module 24 or through a variety of means. Further, the data collected may be stored in memory 22 within the system 10. In addition to the data collector 20 collecting data through the social networking sites' open application programming interfaces, a data collector 20 may collect data from social networking sites 4 in a variety of ways. For example, data from social networking sites may be gathered through partnerships with the social networking sites. For example, partners may be provided with software programming code to place on their web pages, making it easy for partners to utilize the invention.

In addition, user profile information, a social network graph, other information about social network connections, or other public or private data about the user may be gathered from individual users about the user. For example, data can be attained from an individual user about that user, or from an individual user about a network connection. In addition, information may be obtained from a network connection to ascertain information about a user. One of ordinary skill in the art can appreciate that there are a variety of other ways that such data may be collected from social networking sites and there are a variety of other types of data that may be collected from social networking sites.

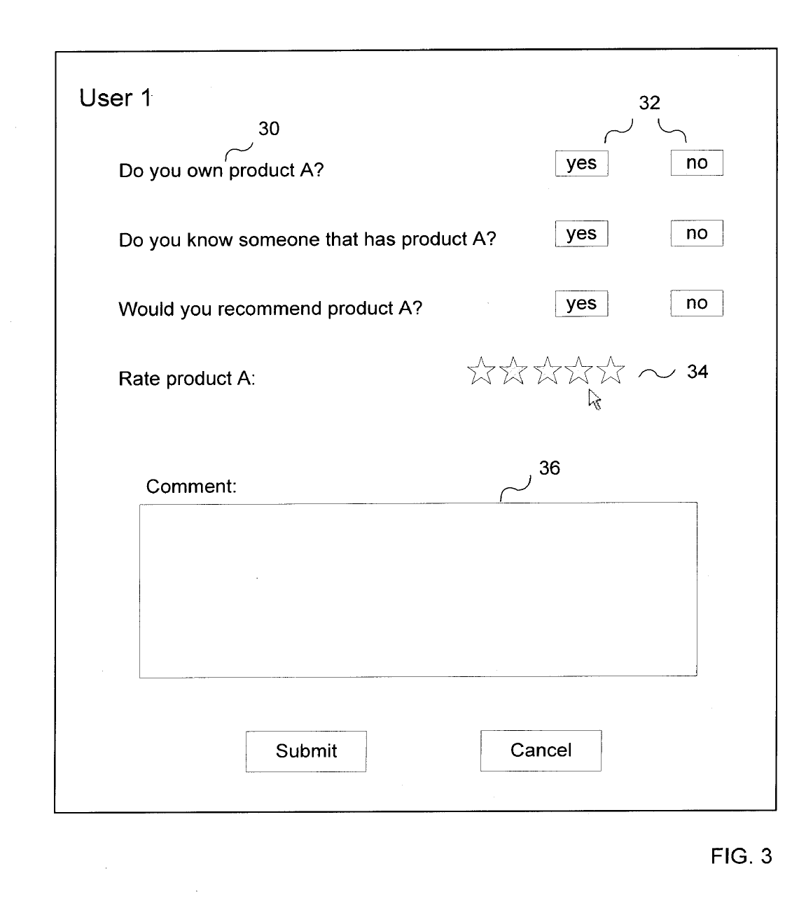

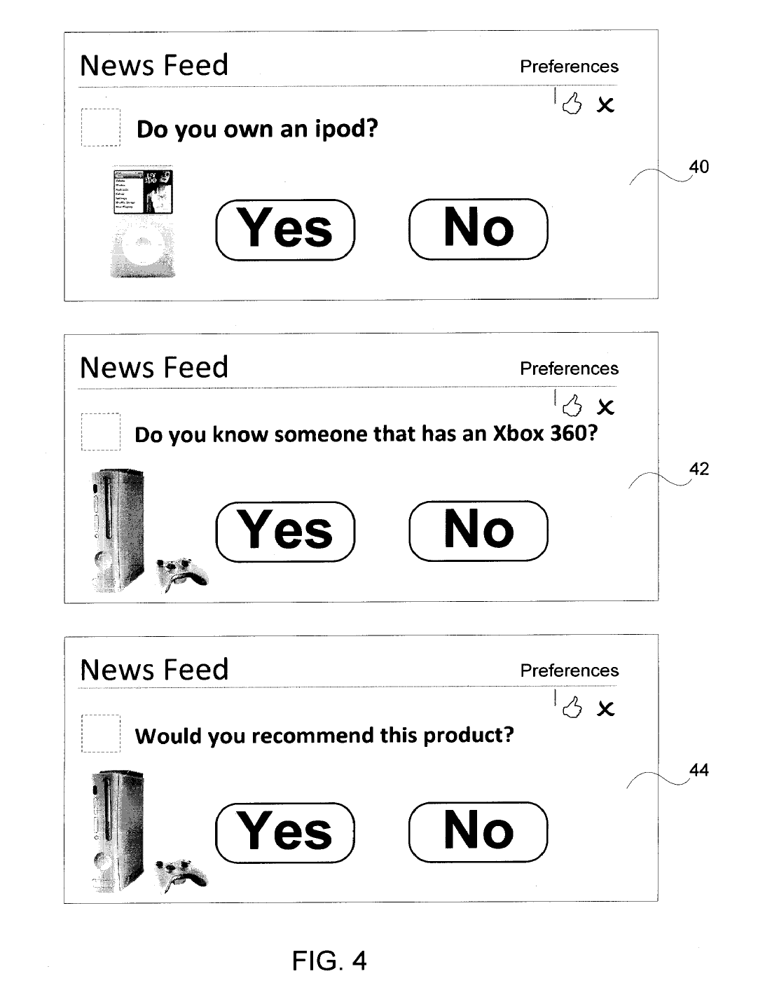

Another embodiment of the invention further provides for gathering of data from sites with user review and advocacy data. Alternatively, data could be gathered from any site with CGM, and any type of CGM may be collected. In one embodiment, messages between users, ratings on products, data on which users own certain products, product recommendations, suggestions on where to buy products, product alternatives, etc. are just a few examples of the many types of CGM that may be collected from various sites. Such data could be gathered through the application programming interfaces of the sites that the information is stored on. In another embodiment of the invention, data may be gathered through partnerships with other social networking sites or other web sites visited by users. Referring to FIG. 3, in any of the foregoing platforms, data may be gathered through direct questions with the users 30, and users may have the option of responding “yes” or “no” 32 to various questions or alternatively, providing a rating or response on a scale 34. Referring to FIG. 4, as an example, and without limiting the scope of the invention, data may be gathered through “feeds” which query the user for information about particular products, ownership of products, product recommendations, etc. To illustrate, queries to the user may include questions such as, “Do you own this product?,” 40 or “Do you know someone that has this product?,” 42 or “Would you recommend this product?,” 44 or “Please rate this product.” Further, users may provide comments or submit text in a comment box 36. These questions may be asked while users browse a social network, after they submit a query to a search engine, or in a variety of other contexts.

Although the scope of the invention is not limited in this respect, embodiments of the invention may collect relationships between users, i.e. the social network data of a user, as well as user profiles, on other non-social networking sites. In one embodiment of the invention, this data can be merged with data stored on social networking sites to create a Universal Profile for each user and can include all of the information collected for that user. The Universal Profile of each user may also include a social network graph to show the user's connections to other user's Universal Profiles. In other words, the social network graph (connections) will also be part of the Universal Profile and will connect each users Universal Profile to the Universal Profiles of the users in their social graph. Further, the Universal Profile of each user may collect answers 32 to various direct questions 30 asked directly to the user, any product ratings 34 that the user has entered, or any comments 36 that the user has submitted for particular products or other material. It can appreciated by those skilled in the art that the Universal Profile may include numerous types of CGM generated by the user in a variety of contexts.

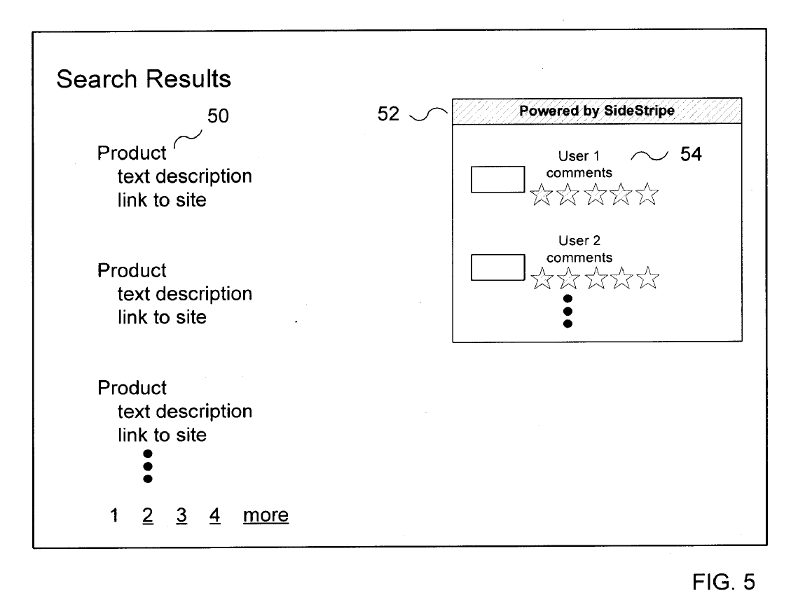

Referring to FIG. 5, in one embodiment of the invention, when a user performs a search on the Internet, the system may provide the most appropriate and most relevant responses based on what the user is searching for and the data contained within that user's realm of network connections. These relevant responses may be displayed in a sidebar 52, or alternatively, on a different region of the web page, such as on the top of the page. In this way, the system may customize search results for each user, so that the user will see results relating to their search in a sidebar 52, or alternatively, on a different region of the web page. Within the sidebar 52, for example, or in another region of the web page the system may display various information found in the Universal Profiles of users within the user's social network graph or other information relating to users within the user's social network graph 54, including user names, profile information, rating of a product, a comment, a review, etc., and may also show the connection relationship between the users. Further, the system may present the user with links for asking the other user a question or sending a message through the system, or an option to get more information about that user or his or her opinions.

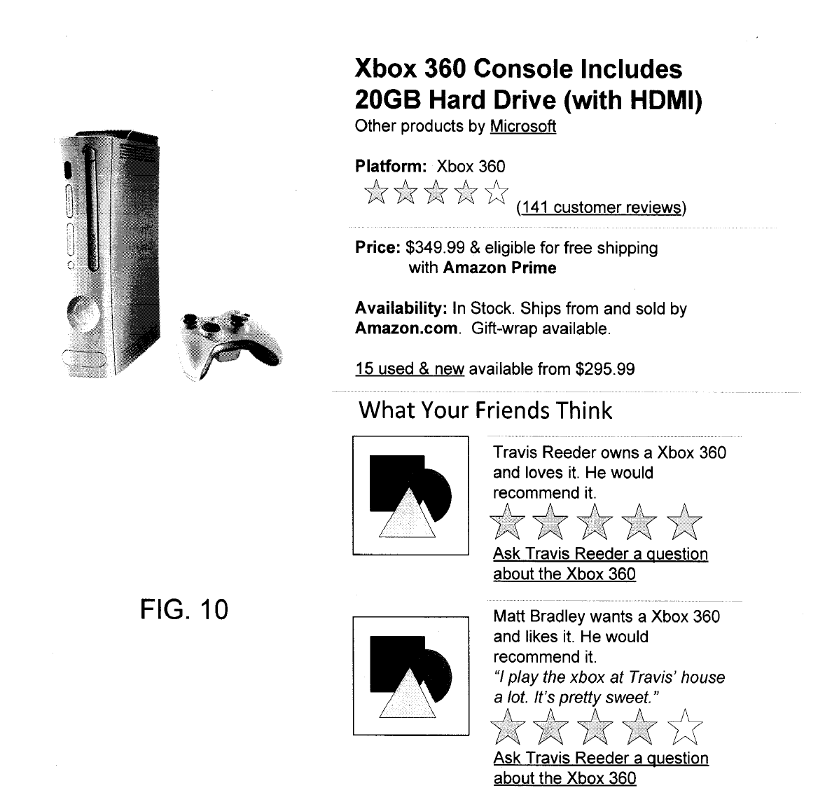

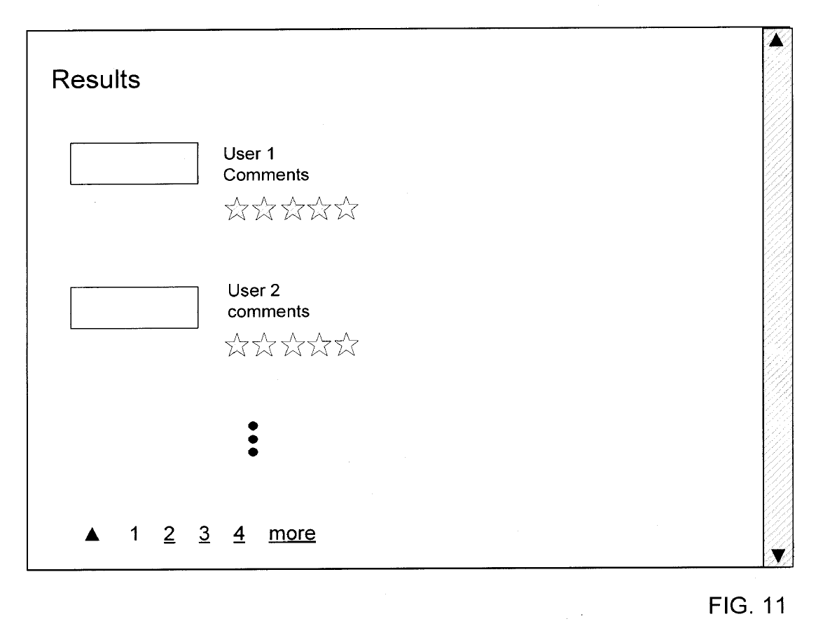

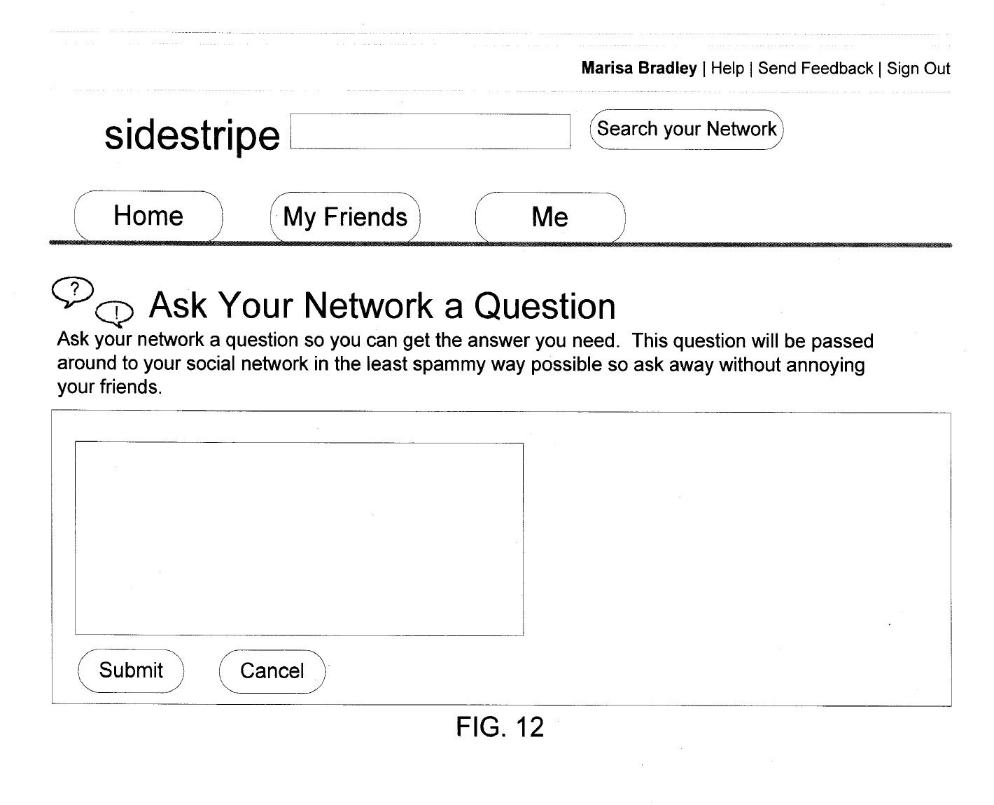

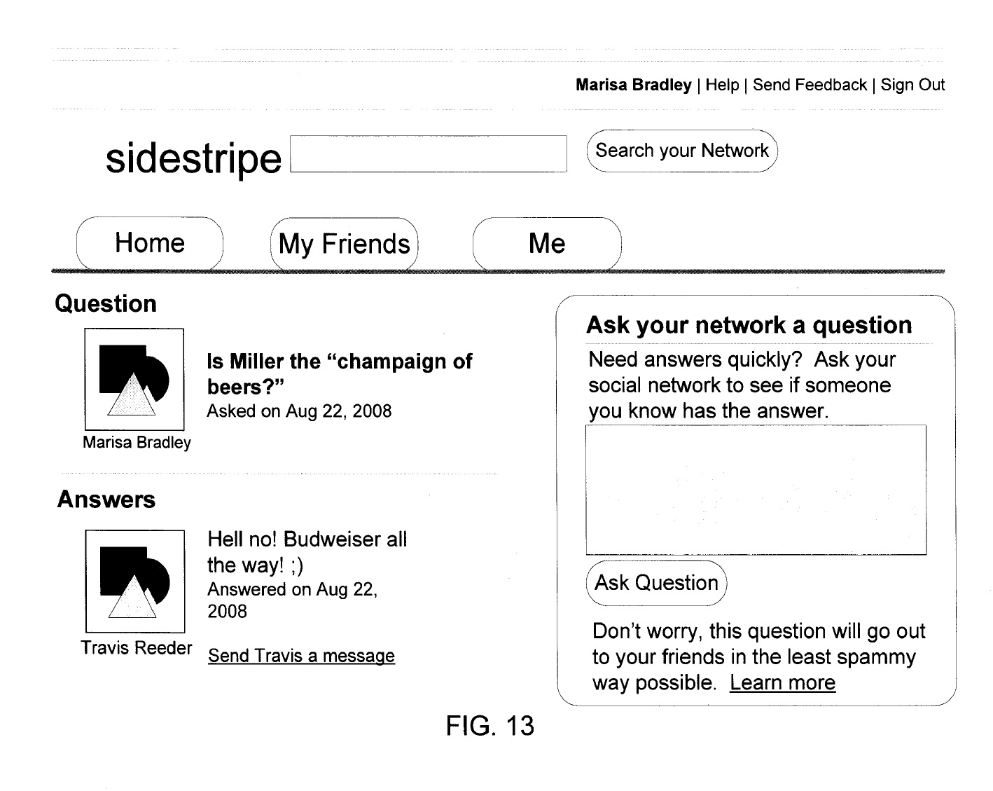

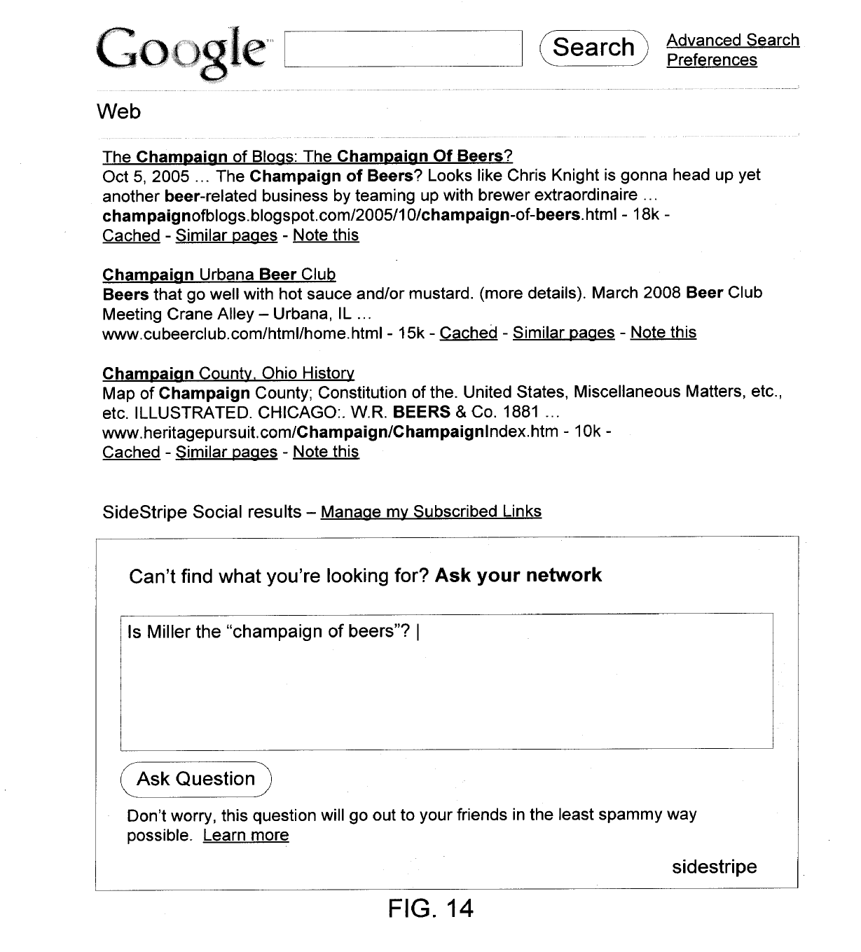

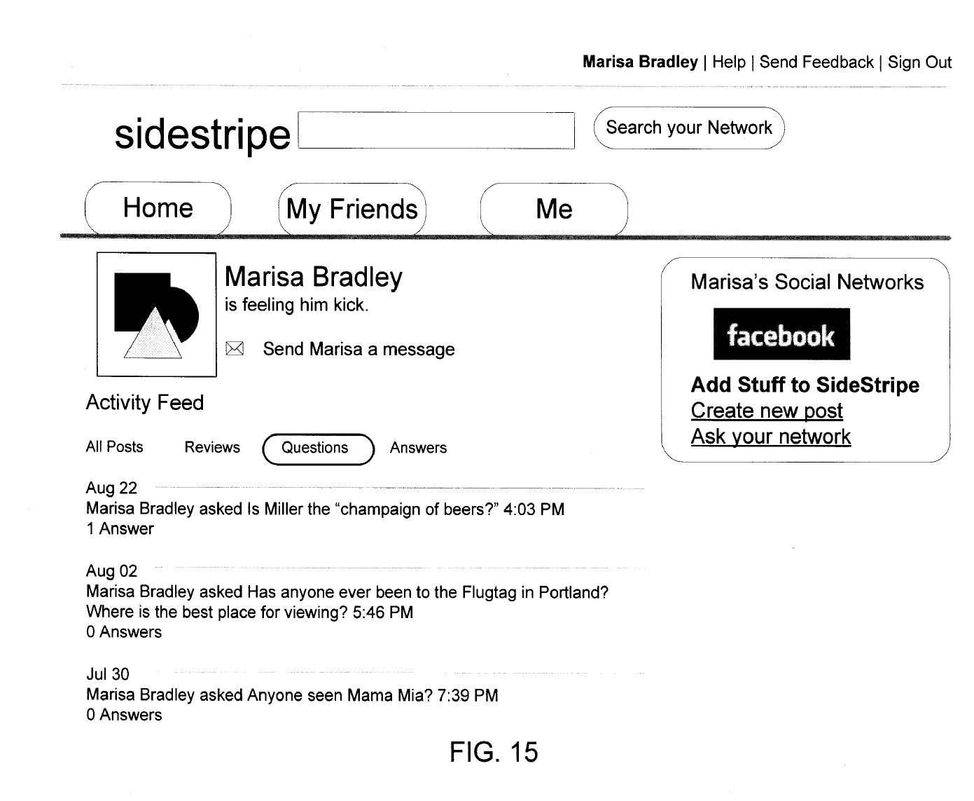

In addition, the relevant responses based on what the user is searching for and the data contained within that user's realm of network connections may be displayed in a web page as shown in FIG. 10. The system may display various information and data found in the Universal Profiles of users within the user's social network graph or other information relating to users within the user's social network graph, as described above in the foregoing embodiments. For example, user names, profile information, rating of a product, a comment, a review, etc. may be displayed on the web page. In addition, the connection relationship between users may be displayed on a web page. Thus, it is understood that in each of the embodiments described in this application, any information that can be displayed in a sidebar may also be displayed outside of a sidebar, without the sidebar, or on a web page by itself.

In another embodiment of the invention, the system may deliver the sidebar 52 or the information or data generated by the system to its partners. For example, partners may be provided with a small code snippet to place on their pages, making it very easy for partners to get started. To show relevant results, the partner site can pass in search keywords to the code that they have placed on their page, which will then display the relevant results. It is further understood that the invention is not limited to using a sidebar 52 to display the results, but that the results may be displayed without a sidebar, in a pop-up, in a widget, or in a stand-alone web page.

In another embodiment of an invention, the system may show degrees of separation of connections, including the relationship between two users as well as how many steps away they are from a person in the social network. Thus, the system may have the capability to show nth degree relationships, such as, and without limiting the scope of the invention, “X's friend Y has a product.” The connection may show their relationship, such as how many steps away they are from a person in the social network. For further illustration, for example, when a user submits a query to a search engine, the system may populate a sidebar 52 with results relating to their search, or alternatively, the system may show this information on a different region of the web page. Within the sidebar 52, for example, or in another region of the web page, the system may show the degree of separation between the user and other users within that user's social network graph, along with other information, including user names, profile information, rating of a product, a comment, a review, etc. Further, users may set preferences so that the system only shows information, including user names, profile information, ratings of a product, comments, reviews, etc. of other users within the social network graph within a specified degree of separation. For example, a user may want to set a preference so that only information relating to users within two degrees of separation appears within the sidebar 52. It is understood that the invention is not limited to using a sidebar 52 to display the results, but that the results may be displayed without a sidebar, in a pop-up, in a widget, or in a stand-alone web page.

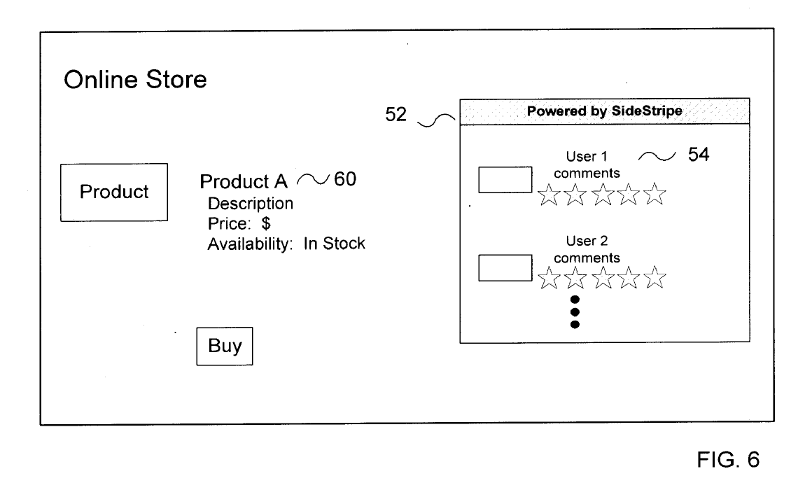

Referring to FIG. 6, according to one embodiment of the invention, the system may integrate with other product sites, searching sites, or any site which presents information, to provide the social network information integrated or in a different context. For example, and without limiting the scope of the invention, the system may integrate with sites such as Amazon.com or Google.com or other web sites to provide information in a different context. Information can be displayed in a sidebar relating to search results or particular products, displayed in a pop-up, in a widget, or displayed in a stand-alone web page, as stored or submitted by other users in a user's social network graph. In the context of an online store, for example, a user may view information about a particular product 60, and the system may display CGM created by users 54 within the social network graph relating to the particular product 60. Such information may be displayed in a sidebar 52, in a pop-up, elsewhere on the web page, in a widget, or on a stand-alone web page. Such information may be valuable to the user in evaluating a particular product 60, especially because it was submitted by users within a social network graph.

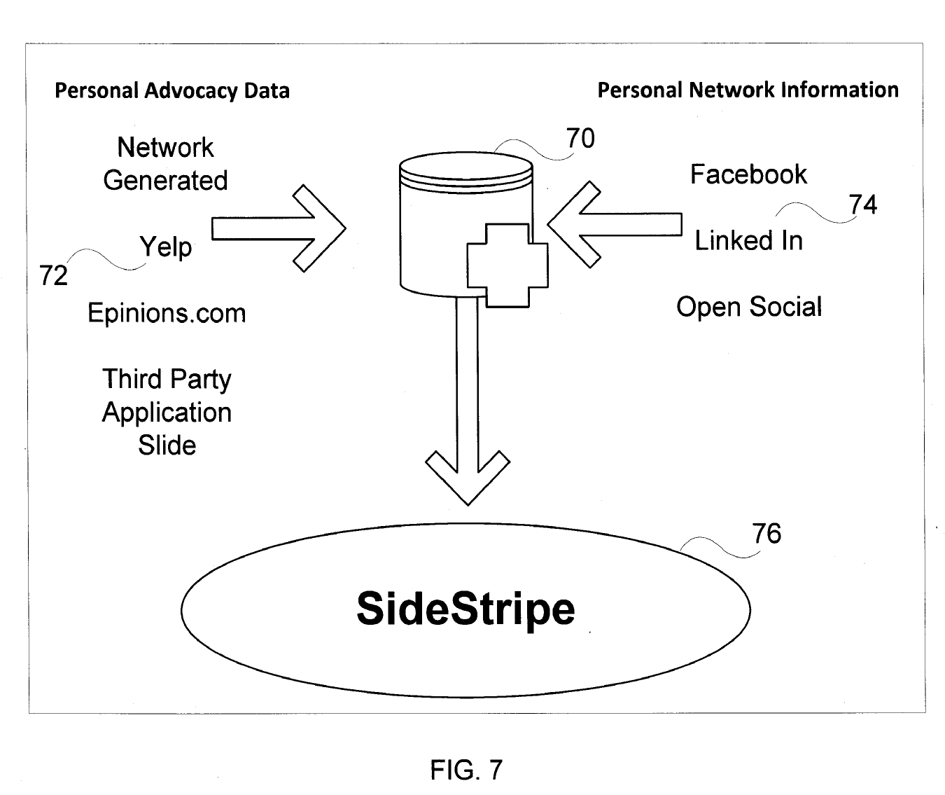

Referring to FIG. 7, according to another embodiment of the invention, the system 76 takes information from social networks 74, sites with information like reviews including Amazon.com, Epinions.com, and Yelp.com 72, and the system's own applications and merges the data together to provide relevant information to a user that is looking for something. This information is from people they know, and thus may be relevant to a user who conducts a search or other operation. In one embodiment, there may be at least two parts to the system 76: (1) data gathering, and (2) user search. The data gathering system could be for collecting user information to be stored in a sidebar. There may be at least two types of information collected: (1) social network data, and (2) user review and advocacy data. Social network data may include information collected from current social networks such as Facebook or LinkedIn or other sites that participate in OpenSocial via their open application programming interfaces and partnerships. Social network data may include profile information and social network graph and network connections, or additionally, even private or otherwise non-public data about users that is collected by the social network. User review and advocacy data may have various sources including (1) data partnerships with sites like Yelp.com, Amazon.com, Epinions.com or other inbound information via application programming interfaces; (2) questions or reviews via social networks including asking questions through social network or partner sites on social networks and asking questions after a search is done; (3) manual data gathering including one user entering data stating that network connection is expert in a certain area or data can be attained from a user about that user, or from a user about a network connection, or from a network connection about that user; (4) social relationship data or network connections via social networks such as Facebook or LinkedIn, or sites that participate in OpenSocial.

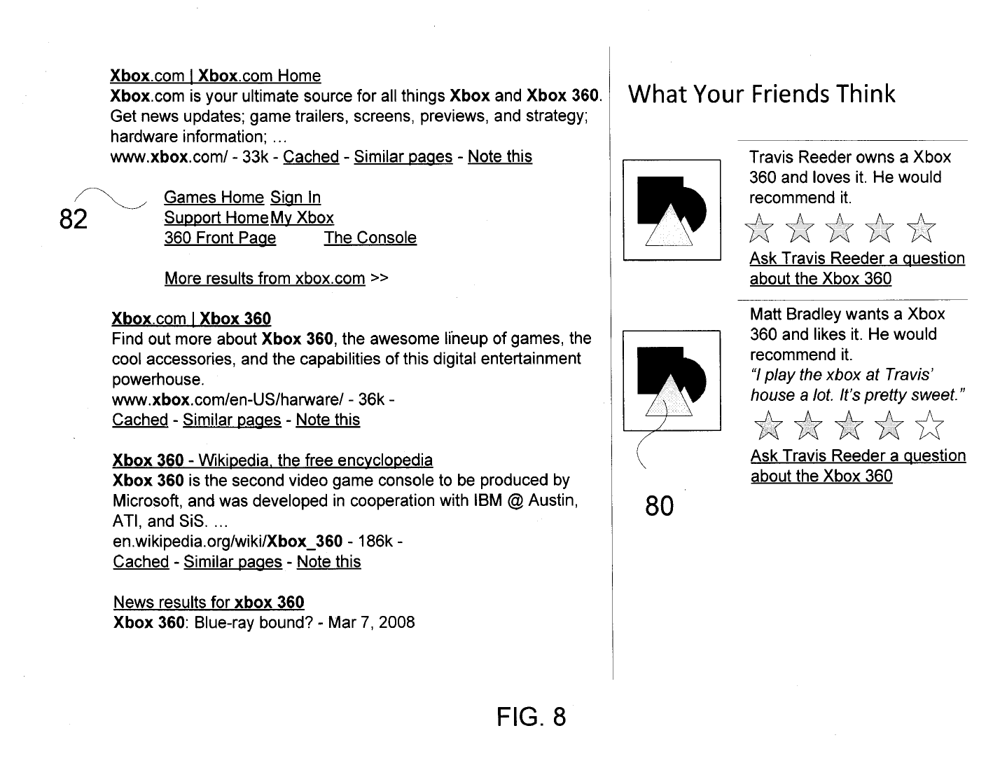

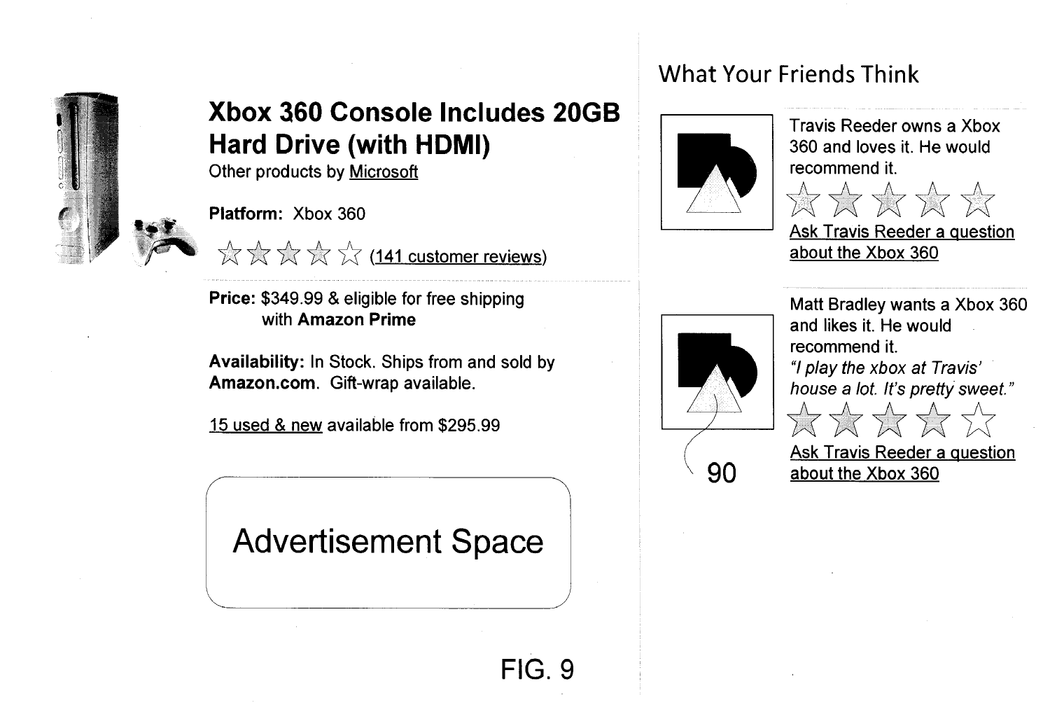

Referring to FIG. 8, in a user search interface, the end user may see results related to their search in a sidebar 80 or top, in a pop-up, in a widget, or on a stand-alone web page depending on a partner's preference. The results in a sidebar 80 (or pop-up, widget or stand-alone web page) will be related to their search and may show: (1) connection's name and relationship, (2) connection's rating of a product, (3) connection's comment or review, or (4) link to actions such as asking a person a question or getting more information on a user opinion, or any combination of the above. In addition, referring to FIG. 9, in a product store interface, the end user may see results related to a product that they are viewing in a sidebar 90 or top, in a pop-up, widget or on a stand-alone web page depending on a partner's preference. In this example, the system is being integrated with Amazon.com to provide the same information in a different context. The sidebar may be located anywhere on the page or the results may be displayed simply on the web page as shown in FIG. 10 or otherwise integrated with data on the web page.

It will be appreciated that in each of the embodiments described in this application, the results displayed are not limited to being displayed in a sidebar, in a pop-up, widget, or any particular location, but that various embodiments of the invention contemplate displaying the results in a number of ways. For example, in FIG. 10, the results are displayed on a web page by itself. Further, it can be appreciated that there are a number of ways the results can be displayed, and the results and data generated may be integrated by partners on the partner's web pages in a number of ways.

Further, another embodiment of the invention may match keywords from a user initiated search query to messages sent between users in social networks. Keywords from a search may be matched to messaging. For example, a user can write a message and then connect it to specific keywords. When a user does a search and it hits that keyword, their network will see the message in the sidebar. In addition, in one embodiment, messages sent between users may be gathered from social networking sites through their open application programming interfaces or through partnership relationships with the social networking sites. The messages may be collected in the system as part of a user's Universal Profile or otherwise related to the user's Universal Profile. As such, the system will have access to the content of such messages and can search such messages for certain keywords, as submitted by a user in a search query. Thus, when generating customized search results for a user, the system may show messages containing certain keywords in the user's search queries as part of the user's search results in the sidebar, or alternatively, in a different region on the web page. The customized search results and messages may also be displayed in a pop-up, widget, or on a web page by themselves or as integrated with other data and information. The messages may be useful to a user in evaluating the relevance of a particular search result.

According to one embodiment of the invention, an advertiser may use the invention in order to select which endorsements to show to the user. Such endorsements may be shown in a sidebar, on top of the page, in a pop-up, in a widget, on a separate web page, or elsewhere on the page, when a user enters certain keywords into the user's search query. In one embodiment, the endorsements may be competitive in that the user may be shown products or results that are competitive to the keywords that the user is looking for. In another embodiment, the results may be complementary, showing social network data, user reviews or advocacy data collected by the system for a certain product keyword, for example. In another embodiment, product endorsements or other kinds of endorsements may be shown based on a topic or based on certain keywords entered by the user. For example, and without limiting the scope of the invention, if a user searches for a certain product, an advertiser may want to display an ad for a competitive product in the results of that search, or alternatively, for a complementary user review for the product in the results of that search. As one example, if a user searches for “Xbox” then an advertiser may want to display results for “Playstation” products in a sidebar, on top of the page, elsewhere on the page, in a pop-up, or on a different web page, including user reviews or advocacy data or data collected from social networks for a “Playstation” product.

Referring to FIG. 12, in one embodiment of the invention, a user may utilize the interface to ask the user's social network a question. This question may be asked while searching or browsing on the Internet. It may be asked, targeted (or delivered) to members in their social network, or can be targeted to certain people who have certain profile characteristics that are best suited to answer their questions. This function of asking a question to their network may be performed either on a standalone site as shown in FIG. 12, or alternatively, in a widget as shown in FIG. 13 on any webpage or in a search engine.

For example, referring to FIG. 14, if a user does a simple web search, but cannot find the answer that they are looking for or the webpage that they are searching for, they may ask their network of connections or other users a specific question. This question may be delivered to members of their social network, or a subclass of members within their social network, and the user may arrive at a better or more informative answer than a web search without such a feature. When other users in a social network browse their social networks, visit their friend's or connections profile sites, or other functions, they may be shown the question that another user in their network asked, as shown in FIG. 15. These questions may be, for example, shown via an “activity feed” or through a messaging system, on a message board, or in a variety of ways, not to be limited to those disclosed herein.

All concepts of the invention may be incorporated into current social network search engines, including but not limited to those described in U.S. Patent Pub. No. 2007/0112761 A1 (Xu et al.) published on May 17, 2007 and U.S. Patent Pub. No. 2006/0235873 A1 (Thomas) published on Oct. 19, 2006, which are hereby incorporated by reference in their entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for integrating data from social networks, the method comprising:
gathering social network information from a plurality of preselected social networking sites associated with a user;
obtaining a search item from the user or relevant page content from a webpage;
gathering data about the search item obtained from the user or relevant page content from the webpage; and
integrating the social network information and the search item data or relevant page content for display.

2. The method of claim 1, wherein the integrated social network information and search item data is displayed in a search result.

3. The method of claim 1, wherein the integrated social network information and search item data is displayed in a sidebar.

4. The method of claim 1, wherein the integrated social network information and search item data is displayed in a widget.

5. The method of claim 1, wherein the integrated social network information and search item data is displayed on a separate webpage.

6. A system for integrating data from social networks, the system comprising:
a plurality of preselected social networking sites containing aggregated social network information; and
a plurality of data accessible by a search engine that can receive search requests from a user search interface.

7. The system of claim 6, wherein the aggregated social network information includes at least one of the following: social network structure or profile information.

8. The system of claim 6, further comprising: a plurality of web page data relating to the search requests received from the user search interface.

9. A user interface for searching social network data, the user interface comprising:
a first display area for displaying a search field that can receive requests for a search; and
a second display area for displaying results from the search that are derived from at least one database containing aggregated social network data from multiple selected social networks.

10. The user interface of claim 9, wherein the first display area is a widget on a webpage.

11. The user interface of claim 9, wherein the second display area is a widget on a webpage.
